(19) United States
(12) Patent Application Publication
(10) Pub. No.: US 2024/0269771 A1
(43) Pub. Date: Aug. 15, 2024

(54) LASER WELDING METHOD, LASER WELDING DEVICE, AND COMPUTER PROGRAM PRODUCT

(71) Applicant: TOYOTA JIDOSHA KABUSHIKI KAISHA, Toyota-shi (JP)

(72) Inventors: Shotaro KUROKAWA, Nisshin-shi (JP); Kohei TAKAHASHI, Nisshin-shi (JP); Tomohiko SEKIGUCHI, Nagakute-shi (JP)

(73) Assignee: TOYOTA JIDOSHA KABUSHIKI KAISHA, Toyota-shi (JP)

(21) Appl. No.: 18/396,833

(22) Filed: Dec. 27, 2023

(30) Foreign Application Priority Data
Feb. 9, 2023 (JP) 2023-018048

(51) Int. Cl. B23K 26/24

(52) U.S. Cl. CPC B23K 26/24

(57) ABSTRACT

A laser welding method is a laser irradiating method for irradiating with a laser beam an irradiation target surface of a welding target formed by a plurality of overlaid metal plates, and welding the plurality of metal plates, the plurality of metal plates include a first metal plate that forms the irradiation target surface, and a second metal plate, and the laser welding method includes: a first process of irradiating the irradiation target surface with the laser beam, thereby welding the plurality of metal plates, and forming a welded part; and a second process of irradiating with the laser beam a target range of the irradiation target surface including at least part of the welded part, and remelting at least the first metal plate without remelting the second metal plate among the plurality of metal plates after the first process.

### CROSS REFERENCE TO RELATED APPLICATIONS

This application is based upon and claims benefit of priority from Japanese Patent Application No. 2023-18048, filed on Feb. 9, 2023, the entire contents of which are incorporated herein by reference.

### BACKGROUND

### Field

The present disclosure relates to a laser welding method, a laser welding device, and a computer program product.

### Related Art

Conventionally, there have been known techniques for reducing welding defects when metal plates are welded (see, for example, JP 2010-023048 A). According to a conventional method, a portion having a gap is subjected to first laser beam irradiation for melting an upper plate and reducing the gap, and second laser beam irradiation for performing laser beam irradiation to penetrate a lower plate to a back side thereof.

However, it is concerned that, when laser beam irradiation is performed to penetrate the lower plate to the back side thereof at a time of the second laser beam irradiation, the lower plate is melted up to the back side, therefore a shrinkage force at a time of solidification increases, and a solidification crack is produced.

### SUMMARY

The present disclosure may be implemented as a following aspect.

According to one aspect of the present disclosure, there is provided a laser welding method for irradiating with a laser beam an irradiation target surface of a welding target formed by a plurality of overlaid metal plates, and welding the plurality of metal plates. The plurality of metal plates include a first metal plate that forms the irradiation target surface, and a second metal plate that forms a surface of the welding target on a side opposite to the irradiation target surface. The laser welding method includes: a first process of irradiating the irradiation target surface with the laser beam, thereby welding the plurality of metal plates, and forming a welded part; and a second process of irradiating with the laser beam a target range of the irradiation target surface including at least part of the welded part, and remelting at least the first metal plate without remelting the second metal plate among the plurality of metal plates after the first process.

### BRIEF DESCRIPTION OF THE DRAWINGS

FIG. 1 is a schematic view illustrating a configuration of a laser welding device;

FIG. 2 is a flowchart illustrating a procedure of a laser welding process;

FIG. 3 is an explanatory view schematically illustrating each process of the laser welding process;

FIG. 4 is a flowchart illustrating a procedure of a laser welding process according to a second embodiment; and

FIG. 5 is an explanatory schematically illustrating each process of the laser welding process according to the second embodiment.

### DETAILED DESCRIPTION

### A. First Embodiment

### A1. Laser Welding Device

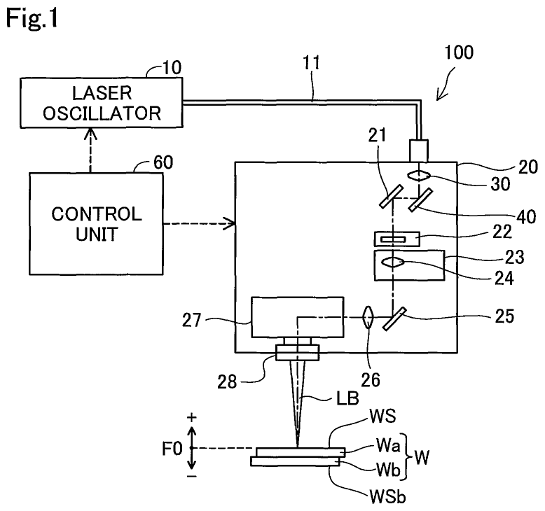

FIG. 1 is a schematic view illustrating a configuration of a laser welding device 100 used to radiate a laser beam LB in a laser welding process. As illustrated in FIG. 1, the laser welding device 100 irradiates with the laser beam LB an irradiation target surface WS of a welding target W formed by a plurality of overlaid metal plates. More specifically, in the present embodiment, the plurality of metal plates are two metal plates, and include a first metal plate Wa and a second metal plate Wb. The first metal plate Wa forms the irradiation target surface WS. The second metal plate Wb forms a back surface WSb that is a surface of the welding target W on a side opposite to the irradiation target surface WS. In the present embodiment, respective materials of the first metal plate Wa and the second metal plate Wb are aluminum. When the welding target W is irradiated with the laser beam LB, the first metal plate Wa and the second metal plate Wb are welded. Note that the materials of the metal plates to which the laser welding method according to the present disclosure is applied may be not only aluminum, but also light metals such as magnesium, iron, copper, and the like.

The laser welding device 100 includes a laser oscillator 10, a laser scanner 20 that is a laser beam irradiation unit, and a control unit 60.

The laser oscillator 10 oscillates the laser beam LB. The laser oscillator 10 and the laser scanner 20 are connected via an optical fiber cable 11. The laser scanner 20 includes a collimator lens 30, a dichroic mirror 40, a first reflection mirror 21, a Diffractive Optical Element (DOE) 22, a Z lens driving unit 23, a second reflection mirror 25, a condenser lens 26, a galvanometer scanner unit 27, and a protection glass 28.

The laser beam LB emitted from the laser oscillator 10 enters inside the laser scanner 20 through the optical fiber cable 11. Furthermore, the laser beam LB is adjusted to a parallel state by the collimator lens 30. Subsequently, the laser beam LB is reflected by the dichroic mirror 40 and the first reflection mirror 21, and reaches the DOE 22.

The DOE 22 adjusts an irradiation pattern of the laser beam LB. More specifically, the DOE 22 radiates the incident laser beam LB as the laser beam LB having a different power density distribution shape from that at a time when the laser beam LB is incident.

The laser beam LB adjusted by the DOE 22 reaches a Z lens 24 built in the Z lens driving unit 23. The Z lens driving unit 23 includes a moving mechanism that moves a position of the Z lens 24 in an optical axis direction, and a driver that drives the moving mechanism. Furthermore, when the position of the Z lens 24 in the optical axis direction moves, a focal position of the laser beam LB radiated from the laser scanner 20 is changed.

Subsequently, the laser beam LB is reflected by the second reflection mirror 25, and is incident on the galvanometer scanner unit 27 through the condenser lens 26. The galvanometer scanner unit 27 includes a mirror that reflects the laser beam LB, a changing mechanism that changes the angle of the mirror, and a driver that drives the changing mechanism. Furthermore, the galvanometer scanner unit 27 changes an irradiation position of the laser beam LB on the irradiation target surface WS of the welding target W by changing the angle of the built-in mirror. The laser beam LB emitted from the galvanometer scanner unit 27 is radiated on the irradiation target surface WS of the welding target W through the protection glass 28.

The control unit 60 is configured as a computer that includes a CPU and a memory. The memory stores a laser welding program for executing the laser welding process. The control unit 60 controls the laser oscillator 10 and the laser scanner 20 by executing the laser welding program stored in the memory. More specifically, the control unit 60 instructs an output value of the laser beam LB to the laser oscillator 10. Furthermore, the control unit 60 instructs the focal position to the Z lens driving unit 23 as a distance whose direction to approach the laser scanner 20 based on a predetermined reference focal position F0 is a plus direction, and whose direction to move away from the laser scanner 20 is a minus direction. When the welding target W is disposed such that the position of the irradiation target surface WS and the reference focal position F0 match, the focal position is shifted from the reference focal positon F0, and then an irradiation diameter that is the diameter of a substantially circular irradiation range of the laser beam LB on the irradiation target surface WS becomes large.

A state where the focal position of the laser beam LB matches with the irradiation target surface WS is referred to as a just focus state. A state where the focal position of the laser beam LB is between the laser scanner 20 and the irradiation target surface WS is referred to as a defocus state. A state where the focal position of the laser beam LB is further from the laser scanner 20 than from the irradiation target surface WS is referred to as an in-focus state. The laser beam LB in the defocus state is attenuated compared to the laser beam LB in the in-focus state.

### A2. Laser Welding Process

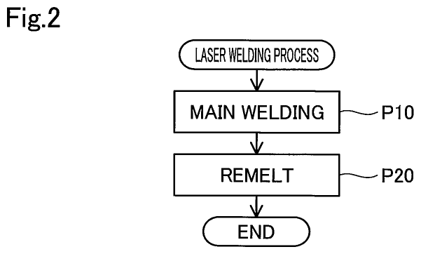

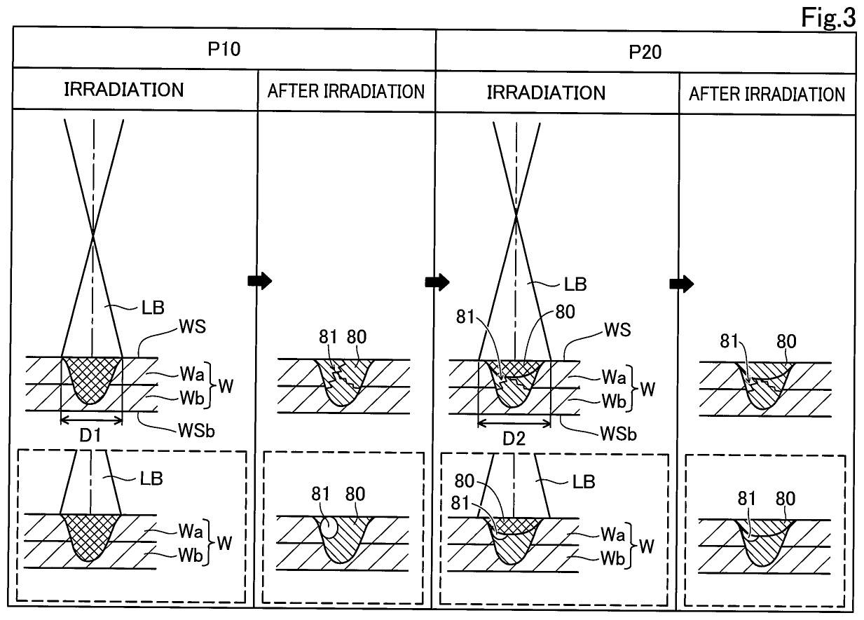

FIG. 2 is a flowchart illustrating a process of the laser welding process that implements a laser welding method according to the present embodiment. FIG. 3 is an explanatory view schematically illustrating a cross section of the welding target W in each process of the laser welding process. In a first process P10 in FIG. 2, when the irradiation target surface WS is irradiated with the laser beam LB, the first metal plate Wa and the second metal plate Wb are welded. In the first process P10, a welded part 80 that is illustrated in FIG. 3 and is a portion at which a metal that has been irradiated with the laser beam LB and thereby melted has solidified is formed. The first process P10 is also referred to as a main welding process.

The first process P10 is executed by performing first processing where the control unit 60 causes the laser scanner 20 to radiate the laser beam LB for welding the first metal plate Wa and the second metal plate Wb and forming the welded part 80. Furthermore, a function exhibited when the control unit 60 performs the first processing is referred to as a first function.

As illustrated as “irradiation in P10” in FIG. 3, non-penetration welding for melting a metal to such a degree that the second metal plate Wb is not melted up to the back surface WSb in the first process P10 according to the present embodiment. In the first process P10, the laser beam LB in the defocus state is radiated. At the time of “irradiation in P10” in FIG. 3, the melted metal portion is indicated by a cross-hatching. As indicated by “after irradiation in P10” in FIG. 3, the portion at which the metal that has been irradiated with the laser beam LB and thereby melted in the first process P10 has solidified is the welded part 80 indicated by a single hatching.

By the way, welding forms a welding defect 81 at the welded part 80 in some cases. “After irradiation in P10” in FIG. 3, a solidification crack that is a crack produced at a solidified portion, and a blowhole that is a cavity formed at the welded part 80 are illustrated as an example of the welding defect 81. A next second process P20 is performed to repair the welding defect 81.

In the second process P20 in FIG. 2, a target range including at least part of the welded part 80 is irradiated with the laser beam LB, the second metal plate Wb is not remelted, and the first metal plate Wa is remelted. That is, in the second process P20, only the first metal plate Wa that is an uppermost metal plate including the irradiation target surface WS is remelted. The second process P20 is also referred to as a remelting process.

The second process P20 is executed when the control unit 60 performs second processing of irradiating the target range including at least part of the welded part 80 in the irradiation target surface WS with the laser beam LB for remelting at least the first metal plate Wa without remelting the second metal plate Wb among the first metal plate Wa and the second metal plate Wb after the first processing. Furthermore, a function exhibited when the control unit 60 performs the second processing is referred to as a second function.

As illustrated in FIG. 3, in the second process P20 according to the present embodiment, the welded part 80 is irradiated with the laser beam LB having a larger irradiation diameter D2 than an irradiation diameter D1 of the laser beam in the first process P10. An irradiation position of the laser beam in the first process P10 is the same as an irradiation position of the laser beam in the second process P20 are the same. Consequently, it is possible to remelt the entire range of the welded part 80 formed in the first process P10 and exposed in the irradiation target surface WS. Hence, it is possible to remelt the metal portion at which the welding defect 81 has been formed irrespectively of the position of the welding defect 81.

In the second process P20, the laser beam LB in the defocus state is radiated. Furthermore, an input heat quality that is a heat quantity input to the welding target W by the laser beam LB in the second process P20 is smaller than an input heat quality of the laser beam LB in the first process P10. The irradiation diameter D2 of the laser beam LB in the second process P20 is larger than the irradiation diameter D1 of the laser beam LB in the first process P10. Consequently, by making the input heat quality in the second process P20 less than the input heat quality of the laser beam LB in the first process P10, it is possible to remelt only the first metal plate Wa. The input heat quantity is adjusted based on irradiation conditions such as a laser output of the laser beam LB, an irradiation time of the laser beam LB, the irradiation diameter of the laser beam LB and the like. In the present embodiment, the laser beam LB under laser conditions that have been obtained in advance by an experiment or the like, and make it possible to remelt only the first metal plate Wa is radiated.

In the second process P20, only the first metal plate Wa that is the uppermost metal plate of the welding target W is remelted. Consequently, it is possible to prevent formation of the new welding defect 81 caused by laser beam irradiation in the second process P20. In a case where the second metal plate Wb is also remelted in addition to the first metal plate Wa unlike the present embodiment, the volume of a melted metal becomes large, a shrinkage stress of the metal at the time of solidification becomes great, and therefore a solidification crack is concerned to be produced. In this regard, according to the present embodiment, by remelting only the first metal plate Wa, it is possible to reduce the volume of the melted metal compared to a case where the second metal plate Wb is also remelted, so that it is possible to prevent formation of a solidification crack that is the new welding defect 81.

Furthermore, in the case where the second metal plate Wb is also remelted in addition to the first metal plate Wa, it is necessary to increase the heat quantity input to the welding target W by laser beam irradiation to melt a metal having a large volume. It is concerned that, when the large heat quantity is input, spatters are produced, and a hole such as a blowhole is formed. In this regard, according to the present embodiment, by suppressing the input heat quantity compared to the case where the second metal plate Wb is also remelted, it is possible to prevent production of spatters, and prevent formation of a blowhole that is the new welding defect 81.

As indicated by “after irradiation in P20” in FIG. 3, the metal that has been melted by laser beam irradiation solidifies in a state where the metal portion at which the solidification crack has been produced is filled so as not to be exposed. Consequently, it is possible to improve decreased strength caused by the solidification crack formed in the first process P10. Furthermore, it is possible to prevent water leakage when the welding target W is used in a mode that causes water to flow between the first metal plate Wa and the second metal plate Wb. To describe in more detail, there is an aspect where each of the first metal plate Wa and the second metal plate Wb has a shape that forms a space for causing unillustrated water to flow between the first metal plate Wa and the second metal plate Wb. In a case of this aspect, the metal melted and solidified in the second process P20 fills the portion that is part of a metal portion at which the solidification crack has been produced, and that is exposed in the irradiation target surface WS, so that it is possible to prevent the water from leaking to the irradiation target surface WS of the first metal plate Wa from between the first metal plate Wa and the second metal plate Wb along the solidification crack.

The frames indicated by the broken lines in FIG. 3 show that the blowhole that is an examples of the welding defect 81 is formed in the first process P10. When the blowhole is formed, too, the metal melt in the second process P20 solidifies to fill a cavity of the blowhole similar to the solidification crack. Consequently, by executing the second process P20, it is possible to improve decreased strength caused by the blowhole formed in the first process P10.

Note that the inventors of the present invention have confirmed that, even when the blowhole is formed in the first process P10, if the volume of the blowhole is approximately half the volume of the metal melted in the first process P10 or less, it is possible to repair the welding defect 81 by performing the second process P20 to satisfy target strength.

According to the above-described first embodiment, the laser welding method includes the first process P10 and the second process P20. In the second process P20, the second metal plate Wb of the two metal plates of the first metal plates Wa and the second metal plate Wb is not remelted. Consequently, it is possible to reduce the volume of the melted metal compared to the case where the second metal plate Wb is also remelted in addition to the first metal plate Wa, so that a shrinkage force at the time of solidification becomes little, and it is possible to prevent production of a new solidification crack caused by radiation of the laser beam LB in the second process P20.

Furthermore, the irradiation diameter D2 of the laser beam LB in the second process P20 is larger than the irradiation diameter D1 of the laser beam LB in the first process P10. Consequently, by remelting the metal portion at which the welding defect 81 has been formed irrespectively the position of the welding defect 81, it is possible to repair the welding defect 81.

Furthermore, a state of the laser beam LB radiated in the second process P20 is the defocus state. Consequently, it is possible to radiate the laser beam LB in the defocus state that is a state where the laser beam LB is attenuated compared to the laser beam LB in the in-focus state. Furthermore, the plurality of metal plates include two of the first metal plate Wa and the second metal plate Wb. The laser welding method according to the present invention is suitable to weld two metal plates.

### B. Second Embodiment

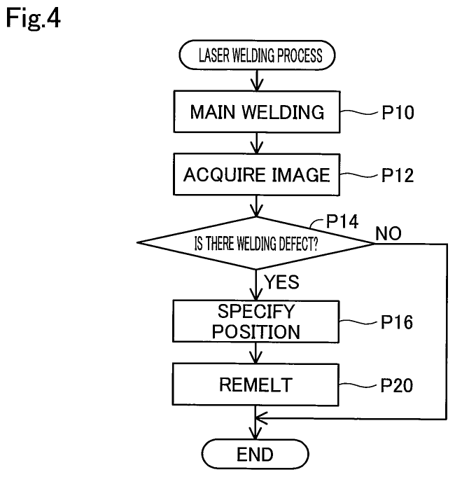

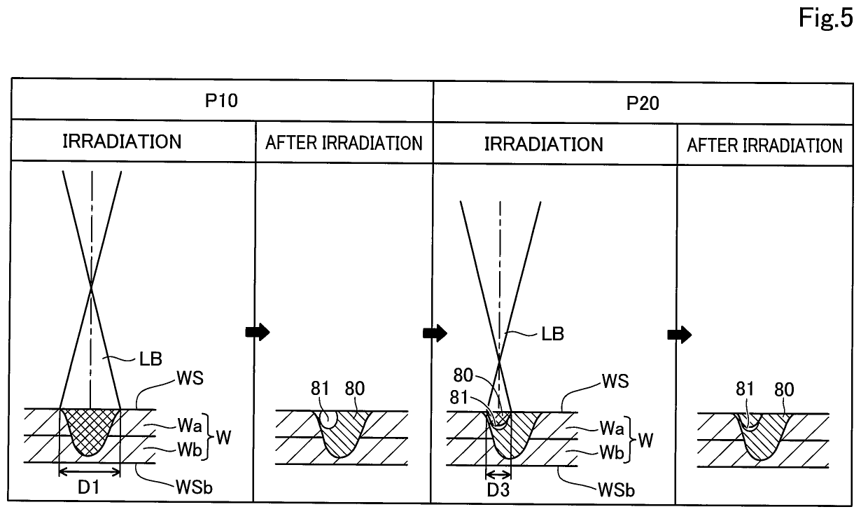

FIG. 4 is a flowchart illustrating a process of a laser welding process according to the second embodiment. FIG. 5 is an explanatory view schematically illustrating each process of the laser welding process according to the second embodiment. The present embodiment differs from the first embodiment in performing an inspection process between the first process P10 and the second process P20, and in an irradiation condition of the laser beam LB in the second process P20. The same components as those of the above first embodiment will be assigned the same reference numerals, and detailed description thereof will be omitted as appropriate.

As illustrated in FIG. 4, after the first process P10 is performed, an image is acquired to inspect a defect in a process P12. More specifically, the laser welding device 100 according to the present embodiment further includes an unillustrated camera that captures an image of the irradiation target surface WS. The image captured by the camera is transmitted to the control unit 60. By using the image captured by the camera, it is possible to check a hole or a crack that is the welding defect 81 formed on the surface of the welded part 80.

In a process P14 in FIG. 4, whether or not there is the welding defect 81 is determined. More specifically, the control unit 60 determines whether or not there is the welding defect 81 by performing image processing on the captured image. Furthermore, in a case where it is determined that there is the welding defect 81, the position of the welding defect 81 is specified in a process P16. The process P12, the process P14, and the process P16 are also referred to as the inspection process.

As another embodiment of the inspection process, whether or not there is the welding defect 81 may be determined by visually checking the image captured by the camera. Furthermore, whether or not there is the welding defect 81 may be determined by irradiating the welded part 80 with a laser beam and using reflected light of the laser beam instead of using the camera.

In a case where it is determined in the process P14 that there is the welding defect 81, the process P16 and the second process P20 are performed. In the second process P20 according to the present embodiment, not the entire portion of the welded part 80 exposed in the irradiation target surface WS, but a portion of the welding defect 81 exposed in the irradiation target surface WS is irradiated with the laser beam LB unlike the first embodiment.

More specifically, the target range irradiated with the laser beam LB in the second process P20 includes the position of the welding defect 81 specified in the process P16. Furthermore, as illustrated in FIG. 5, an irradiation diameter D3 of the laser beam in the second process is smaller than the irradiation diameter D1 of the laser beam in the first process P10. Consequently, it is possible to locally remelt the metal portion of the first metal plate Wa at which the welding defect 81 has been formed.

Furthermore, the laser output of the laser beam LB in the second process P20 is smaller than a laser output of the laser beam LB in the first process P10. In the present embodiment, the irradiation diameter D3 in the second process P20 is smaller than the irradiation diameter D1 in the first process P10. Consequently, by making the laser output of the laser beam LB in the second process P20 smaller than the laser output of the laser beam LB in the first process P10, it is possible to reduce an energy density in the irradiation range of the laser beam LB, and remelt only the first metal plate Wa. Note that, similar to the first embodiment, the laser beam LB under the laser condition that has been obtained in advance by an experiment or the like, and makes it possible to remelt only the first metal plate Wa is radiated in the second process P20.

As illustrated in FIG. 4, after the second process P20 is executed, this laser welding process is finished. Furthermore, in a case where it is determined in the process P14 that there is not the welding defect 81, the process P16 and the second process P20 are skipped, and this laser welding process is finished. Note that, although FIG. 5 illustrates a hole formed in the irradiation target surface WS as an example of the welding defect 81, the present embodiment is applicable even to, for example, a case where a solidification crack is formed in a limited range of the welded part 80.

According to the above-described second embodiment, the second process P20 is executed in a case where it is determined in the process P14 that there is a welding defect, and is not executed in a case where it is determined in the process P14 that there is not a welding defect. Consequently, the second process P20 can be performed only when the welding defect 81 is formed, so that it is possible to efficiently perform welding by omitting the unnecessary second process P20.

Furthermore, the irradiation diameter D3 of the laser beam LB in the second process P20 is smaller than the irradiation diameter D1 of the laser beam LB in the first process P10. Consequently, it is possible to locally remelt the metal portion of the welding defect 81. Consequently, it is possible to reduce the volume of the melted metal, so that the shrinkage force at the time of solidification becomes little, and it is possible to further prevent production of a new solidification crack caused by laser beam irradiation in the second process.

### C. Other Embodiment

(C1) In the above first embodiment, non-penetration welding is performed. The laser welding method according to the present disclosure is applicable to penetration welding of melting the metal to the back surface WSb of the second metal plate Wb to weld. Furthermore, the above first embodiment adopts the welding method that does not perform scanning with the laser beam LB. The laser welding method according to the present disclosure is applicable to a welding method for scanning along a line with the laser beam LB to be radiated. Irrespectively of the welding method of the main welding, in a case where the laser beam LB for repairing the welding defect 81 is radiated, the second metal plate Wb that forms the back surface WSb is not melted, so that it is possible to prevent formation of the new welding defect 81.

(C2) According to the above first embodiment, the plurality of metal plates include the two metal plates of the first metal plate Wa and the second metal plate Wb. The number of the plurality of metal plates is not limited to two. Even in a case where three or more metal plates are welded, the second metal plate Wb that is a lowermost metal plate is not remelted in the second process P20, so that it is possible to reduce the volume of the melted metal compared to the case where the second metal plate Wb is also remelted and, consequently, prevent formation of the solidification crack. Note that a smaller number of metal plates to be remelted in the second process P20 is preferable since the smaller number of metal plates makes it possible to reduce the volume of the melted metal, and reduce the input heat quantity. Hence, in a case where, for example, three metal plates are welded, a method for remelting only the first metal plate Wa in the second process P20 is preferable. In a case where the welding defect 81 is formed in the first process P10, the welding defect 81 such as a blowhole is likely to be formed on the first metal plate Wa that is the uppermost metal plate. Consequently, even when only the first metal plate Wa is melted in the second process P20, it is possible to repair the welding defect 81 by filling a cavity of the blowhole with the metal.

(C3) According to the above second embodiment, in the case where it is determined in the process P14 that there is a welding defect, the metal portion at which the welding defect 81 has been formed is locally remelted in the second process P20. In another embodiment, in a case where it is determined that there is a welding defect, the laser beam LB having the larger irradiation diameter D2 than the irradiation diameter D1 in the first process P10 may be radiated in the second process P20 similar to the first embodiment. In this case, too, the second process P20 is executed in the case where it is determined that there is the welding defect, and the second process P20 is not executed in the case where it is determined that there is not the welding defect, so that it is possible to efficiently perform laser welding.

(C4) According to the above first embodiment, the laser beam LB in the defocus state is radiated in the first process P10 and the second process P20. The laser beam LB radiated in the first process P10 and the second process P20 may be the laser beam LB in the in-focus state instead of the defocus state. Furthermore, the in-focus state and the defocus state of the laser beam LB radiated in the first process P10, and the in-focus state and the defocus state of the laser beam LB radiated in the second process P20 may be different from each other.

The present disclosure is not limited to the above-described embodiments, and can be implemented by various configurations without departing from the gist of the present disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. For example, the present disclosure may be implemented as the aspect described below.
(1) According to one aspect of the present disclosure, there is provided a laser welding method for irradiating with a laser beam an irradiation target surface of a welding target formed by a plurality of overlaid metal plates, and welding the plurality of metal plates. The plurality of metal plates include a first metal plate that forms the irradiation target surface, and a second metal plate that forms a surface of the welding target on a side opposite to the irradiation target surface. The laser welding method includes: a first process of irradiating the irradiation target surface with the laser beam, thereby welding the plurality of metal plates, and forming a welded part; and a second process of irradiating with the laser beam a target range of the irradiation target surface including at least part of the welded part, and remelting at least the first metal plate without remelting the second metal plate among the plurality of metal plates after the first process. According to this aspect, even when a welding defect is formed in the first process, remelting in the second process makes it possible to repair the welding defect such as a solidification crack. In the second process, the second metal plate of the plurality of metal plates is not remelted, so that it is possible to reduce a volume of a melted metal compared to a case where the second metal plate is also remelted. Consequently, a shrinkage force at a time of solidification decreases, so that it is possible to prevent production of a new solidification crack caused by laser beam irradiation in the second process.
(2) According to the laser welding method according to the above aspect, an irradiation diameter of the laser beam in the second process may be larger than the irradiation diameter of the laser beam in the first process. According to this aspect, the entire welded part is remelted, so that it is possible to repair the welding defect irrespectively of a position of the welding defect.
(3) According to the laser welding method according to the above aspect, a state of the laser beam radiated in the second process may be a defocus state. Consequently, according to this aspect, it is possible to radiate the laser beam in the defocus state that is a state where the laser beam is attenuated compared to a laser beam in an in-focus state.
(4) The laser welding method according to the above aspect may further include an inspection process that is performed between the first process and the second process, and inspects whether or not a welding defect has been formed in the first process, and the second process may be executed in a case where it is determined in the inspection process that there is the welding defect, and may not be executed in a case where it is determined in the inspection process that there is not the welding defect. According to this aspect, it is possible to perform the second process only when a welding defect is formed, so that it is possible to efficiently perform welding by omitting the unnecessary second process.
(5) According to the laser welding method according to the above aspect, in the case where it is determined in the inspection process that there is the welding defect, a position of the welding defect may be specified, the target range in the second process may include the specified position of the welding defect, and an irradiation diameter of the laser beam in the second process is smaller than the irradiation diameter of the laser beam in the first process. According to this aspect, by using the laser beam of the small irradiation diameter, it is possible to locally remelt a metal portion of the welding defect of the uppermost metal plate. Consequently, the volume of the melted metal can be decreased, so that the shrinkage force at the time of solidification lowers, and it is possible to further prevent production of a new solidification crack caused by laser beam irradiation in the second process.
(6) According to the laser welding method according to the above aspect, the plurality of metal plates may include two metal plates of the first metal plate and the second metal plate. According to this aspect, the laser welding method is applicable to weld the two metal plates.
The present disclosure may be also implemented by various modes other than the laser welding method. The present disclosure may be implemented as modes such as a laser welding device, a laser welding device manufacturing method, a laser welding device control method, a laser welding program for implementing the laser welding device control method, and non-transitory recording media having this computer program recorded thereon.

What is claimed is:

1. A laser welding method for irradiating with a laser beam an irradiation target surface of a welding target formed by a plurality of overlaid metal plates, and welding the plurality of metal plates, wherein
the plurality of metal plates include a first metal plate that forms the irradiation target surface, and a second metal plate that forms a surface of the welding target on a side opposite to the irradiation target surface, and
the laser welding method comprises:
a first process of irradiating the irradiation target surface with the laser beam, thereby welding the plurality of metal plates, and forming a welded part; and
a second process of irradiating with the laser beam a target range of the irradiation target surface including at least part of the welded part, and remelting at least the first metal plate without remelting the second metal plate among the plurality of metal plates after the first process.

2. The laser welding method according to claim 1, wherein an irradiation diameter of the laser beam in the second process is larger than the irradiation diameter of the laser beam in the first process.

3. The laser welding method according to claim 1, wherein a state of the laser beam radiated in the second process is a defocus state.

4. The laser welding method according to claim 1, further comprising an inspection process of inspecting whether or not a welding defect has been formed in the first process, the inspection process being performed between the first process and the second process,
wherein the second process
is executed in a case where it is determined in the inspection process that there is the welding defect, and
is not executed in a case where it is determined in the inspection process that there is not the welding defect.

5. The laser welding method according to claim 4, wherein
in the case where it is determined in the inspection process that there is the welding defect, a position of the welding defect is specified,
the target range in the second process includes the specified position of the welding defect, and
the irradiation diameter of the laser beam in the second process is smaller than the irradiation diameter of the laser beam in the first process.

6. The laser welding method according to claim 1, wherein the plurality of metal plates include two metal plates of the first metal plate and the second metal plate.

7. A laser welding device that irradiates with a laser beam an irradiation target surface of a welding target formed by a plurality of overlaid metal plates, and welds the plurality of metal plates, the laser welding device comprising:
a laser beam irradiation unit that irradiates the irradiation target surface with the laser beam; and
a control unit that controls the laser beam irradiation unit, wherein
the plurality of metal plates include a first metal plate that forms the irradiation target surface, and a second metal plate that forms the surface of the welding target on a side opposite to the irradiation target surface, and
the control unit executes
first processing of causing the laser beam irradiation unit to radiate the laser beam for welding the plurality of metal plates, and forming a welded part; and
second processing of irradiating a target range of the irradiation target surface including at least part of the welded part with the laser beam for remelting at least the first metal plate without remelting the second metal plate among the plurality of metal plates after the first processing.

8. A computer program product for irradiating with a laser beam an irradiation target surface of a welding target formed by a plurality of overlaid metal plates, and welding the plurality of metal plates, wherein
the plurality of metal plates include a first metal plate that forms the irradiation target surface, and a second metal plate that forms the surface of the welding target on the side opposite to the irradiation target surface, and
the computer program product comprising:
a computer readable medium; and
a computer program stored on the computer readable medium, the computer program causing a computer to implement the functions of:
irradiating the irradiation target surface with the laser beam for welding the plurality of metal plates, and forming a welded part; and
irradiating the target range of the irradiation target surface including at least part of the welded part with the laser beam for remelting at least the first metal plate without remelting the second metal plate among the plurality of metal plates after the first processing.
